(19) United States
(12) Patent Application Publication
(10) Pub. No.: US 2013/0169742 A1
(43) Pub. Date: Jul. 4, 2013

(54) VIDEO CONFERENCING WITH UNLIMITED DYNAMIC ACTIVE PARTICIPANTS

(71) Applicants: Yuguang Wu, Santa Clara, CA (US); Jianming He, Cupertino, CA (US)

(72) Inventors: Yuguang Wu, Santa Clara, CA (US); Jianming He, Cupertino, CA (US)

(73) Assignee: GOOGLE INC., Mountain View, CA (US)

(21) Appl. No.: 13/618,703

(22) Filed: Sep. 14, 2012

Related U.S. Application Data
(60) Provisional application No. 61/581,035, filed on Dec. 28, 2011.

(51) Int. Cl. H04N 7/15

(52) U.S. Cl. 348/14.08; 348/E07.083

(57) ABSTRACT

In general, this disclosure describes techniques for providing dynamic active participants in a real-time visual communication session between two or more participants. When there are more participants in the real-time visual communication session than computing devices connected to the communication session can support visual data from, a subset of the participants are chosen to be active participants. Visual data of the active participants are displayed by one or more of the computing devices. The active participants are chosen based on participation properties. Active participants may become passive and passive participants may become active based on the participation properties. The quality of visual data associated with active participants (e.g., compression rate, output display size, etc.) may be iteratively reduced as one or more of the passive participants become active.

### RELATED APPLICATION

This application claims the benefit of priority to Provisional Application No. 61/581,035, filed Dec. 28, 2011, which is assigned to the assignee hereof and is hereby expressly incorporated by reference herein.

### TECHNICAL FIELD

The disclosure relates to displaying participants in a video conference.

### BACKGROUND

Three or more users of computing devices may often engage in real-time video communications, such as video conferencing, where the users (also referred to as participants) exchange live video and audio transmissions.

### SUMMARY

Techniques of this disclosure provide a method that includes selecting, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants. The method further includes providing, for display, a first set of visual data associated with the one or more active participants on a display device of a computing device. The method also includes selecting one or more newly active participants from one or more participants that were not selected as active participants based at least in part on the one or more participation properties related to the real-time visual communication session, wherein the one or more newly active participants become associated with the active state, and wherein a total number of participants associated with the active state does not exceed a threshold number of active participants. The method includes providing, for display, a second set of visual data associated with the one or more newly active participants on the display device of the computing device, and responsive to providing the second set of visual data for display, modifying a quality of at least part of the displayed first set of visual data.

Another example of this disclosure provides a computer-readable storage medium comprising instructions for causing a programmable processor to perform operations. The instructions include selecting, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants. The instructions further include providing, for display, a first set of visual data associated with the one or more active participants on a display device of a computing device. The instructions also include selecting one or more newly active participants from one or more participants that were not selected as active participants based at least in part on the one or more participation properties related to the real-time visual communication session, wherein the one or more newly active participants become associated with the active state, and wherein a total number of participants associated with the active state does not exceed a threshold number of active participants. The instructions further include providing, for display, a second set of visual data associated with the one or more newly active participants on the display device of the computing device, and responsive to providing the second set of visual data for display, modifying a quality of at least part of the displayed first set of visual data.

Yet another example provides a server comprising one or more processors, the one or more processors being configured to perform a method of selecting, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants. The one or more processors are also configured to provide, for display, a first set of visual data associated with the one or more active participants on a display device of a computing device. The method further includes selecting one or more newly active participants from one or more participants that were not selected as active participants based at least in part on the one or more participation properties related to the real-time visual communication session, wherein the one or more newly active participants become associated with the active state, and wherein a total number of participants associated with the active state does not exceed a threshold number of active participants. The method further includes providing, for display, a second set of visual data associated with the one or more newly active participants on the display device of the computing device, and responsive to providing the second set of visual data for display, modifying a quality of at least part of the displayed first set of visual data.

The details of one or more aspects of the disclosure are set forth in the accompanying drawings and the description below. Other features, objects, and advantages of the disclosure will be apparent from the description and drawings.

### BRIEF DESCRIPTION OF DRAWINGS

FIG. 1 is a block diagram illustrating an example of a computing device that may execute one or more applications and engage in a video conference with one or more other computing devices, in accordance with one or more aspects of the present disclosure.

FIG. 2 is a block diagram illustrating further details of one example of computing device shown in FIG. 1, in accordance with one or more aspects of the present disclosure.

FIG. 3 is a flow chart illustrating an example method that may be performed by a computing device to select active participants from a plurality of participants in a real-time visual communication session, in accordance with one or more aspects of the present disclosure.

FIGS. 4A-4D are a block diagrams illustrating an example graphical user interface that may be provided by a computing device to display visual data of active participants in a real-time visual communication session, in accordance with one or more aspects of the present disclosure.

In accordance with common practice, the various described features are not drawn to scale and are drawn to emphasize features relevant to the present invention. Like reference characters denote like elements throughout the figures and text.

### DETAILED DESCRIPTION

### Overview

Techniques of the present disclosure are directed at functionality for providing dynamic active participants in a real-time visual communication session between two or more participants where network or computer resources for the real-time visual communication session may be limited. Because of the limited resources, such as bandwidth, display screen size, or processing capability, visual data for every participant in the communication session may not be outputted simultaneously. The communication session may only support displaying visual data for a maximum number of participants, even though more users may be participating in the communication session than that maximum number. Therefore, techniques provided herein select some participants to be “active” participants in the visual communication session. Visual data associated with an active participant is provided to user computing devices connected to the communication session for display by the computing devices. Participants that are not selected to be active participants are passive participants, and visual data associated with passive participants are not provided to one or more of the computing devices for display. Thus, a total number of participants that are engaged in a communication session may not be limited by a limit placed on the communication session because of image or other video data.

For example, a communication session may support displaying visual data for a maximum of ten participants. In this particular example, visual data associated with up to ten participants is displayed by a computing device connected to the communication session, while visual data associated with the rest of the participants are not displayed. Those participants whose visual data is being displayed are in an active state (i.e., active participants), while those participants whose visual data is not being displayed are in a passive state (i.e., passive participants). Other data associated with an active participant, such as audio data or other data related to a conference resource, may be outputted by the one or more computing devices.

Techniques provided herein may determine which participants in the real-time video communication session to display associated visual data on a user computing device at any given moment during the video conference. Participants may be selected to be active based at least partially on one or more participation properties related to the real-time visual communication session. Participation properties may include information such as a designation of the participant (e.g., a moderator), a queue of participants who wish to be active, a duration since the participant was last active, and the like. In some examples, participants are selected to be active based on a ranking of participation properties among the participants.

The quality of visual data associated with active participants may be modified as other participants become active. For example, a quality of visual data associated with a previously selected active participant can be iteratively reduced each time a passive participant is made active. That is, as the active participant becomes more senior among the active participants, the quality of the outputted visual data associated with that more senior active participant is reduced. The quality may be based on a greater compression rate, a reduced bit rate of the outputted visual data, a decreased output display size, or other measure of quality.

Example Systems

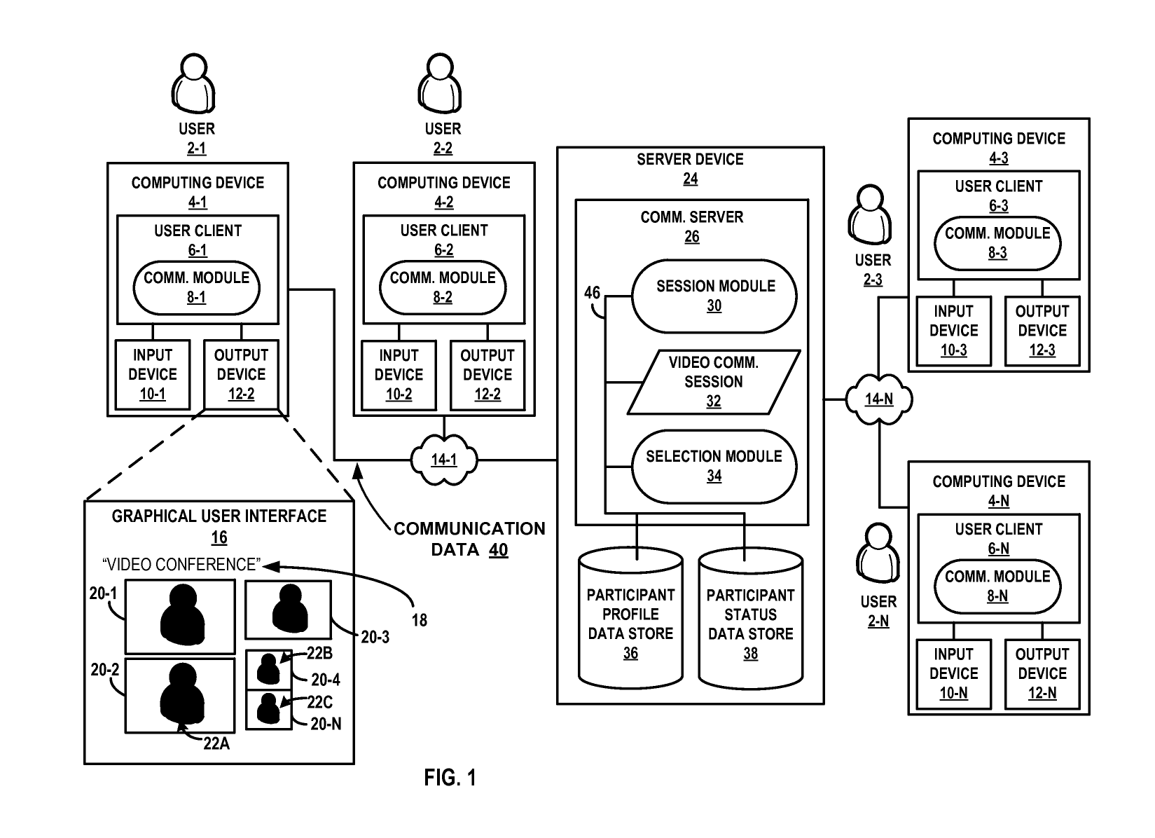

FIG. 1 is a block diagram illustrating an example of one or more computing devices 4-1 through 4-N (collectively referred to herein as “computing devices 4”) coupled to a server device 24 that enables communication between users 2-1 through 2-N associated with computing devices 4, in accordance with one or more aspects of the present disclosure. As used herein, computing devices 4 refer to user computing devices. Users 2-1 through 2-N are collectively referred to herein as “users 2.” Users 2 may also be referred to herein as participants of a real-time visual communication session. Server device 24 selects a set of participants from a plurality of participants in the real-time visual communication session to be active participants and provides visual data associated with the selected active participants for display by computing devices 4.

Users 2 of computing devices 4 may engage in a real-time visual communication session with each other and with other users using other computing devices. For example, computing device 4-1 connects to one or more other computing devices, such as computing device 4-3, through server device 24. In further examples, different numbers of computing devices 4-1 through 4-N may be implemented. For illustrative purposes, FIG. 1 is discussed in terms of a currently ongoing real-time visual communication session between computing devices 4-1 through 4-N.

Computing devices 4 may, in some examples, include or be part of a portable computing device (e.g., a mobile phone, netbook, laptop, personal data assistant (PDA), tablet device, portable gaming device, portable media player, e-book reader, or a watch) as well as non-portable devices (e.g., a desktop computer or a television with one or more processors embedded therein or coupled thereto). For purposes of illustration only, in this disclosure, computing devices 4 are described as portable or mobile devices, but aspects of this disclosure should not be considered limited to such devices. Different computing devices 4 may be different types of devices or may be the same type of devices. In an example where there are six computing devices 4, computing device 4-1 may be a PDA, computing device 4-2 may be a laptop, computing device 4-3 may be a mobile phone, a computing device 4-4 may be a desktop computer, computing device 20-6 may be a laptop, and computing device 20-6 may be a tablet device. Any other numbers and combinations of types of computing devices participating in a real-time visual communication session according to techniques of this disclosure are contemplated. Some of computing devices 4 may include some, all, and/or different functionality than the functionality provided by other computing devices 4.

Computing devices 4-1 through 4-N may include one or more input devices 10-1 through 10-N (collectively referred to as “input devices 10”), one or more output devices 12-1 through 12-N (collectively referred to as “output devices 12”), and user clients 6-1 through 6-N (collectively referred to as “user clients 6”), respectively. User clients 6-1 through 6-N further include communication modules 8-1 through 8-N (collectively referred to as “communication modules 8”).

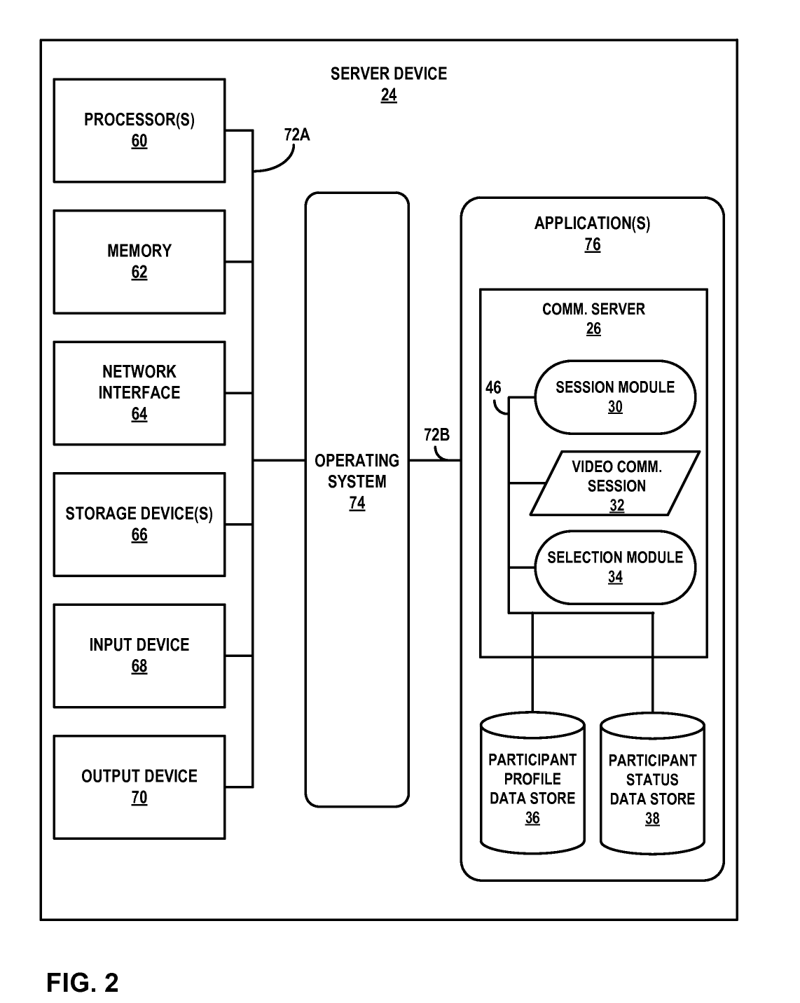

For example, one or more output devices 12-1 of computing device 2-1 may include a display device without input capabilities, a speaker, or the like. One or more input devices 10-1 of computing device 2-1 may include keyboards, pointing devices, microphones, and cameras capable of recording one or more images or video, or the like. In some examples, an input device 10 and an output device 12 may be combined into an input/output device, such as a presence-sensitive screen or a touch screen. That is, in some examples, output device 12-1 may be a display device capable of receiving touch input from user 2-1 (e.g., output device 12-1 may comprise a touch screen, track pad, track point, or the like). User 2-1 may interact with output device 12, for example, by performing touch input on display device 4. One example of computing device 2 is more fully described in FIG. 2, discussed below.

Server device 24 may be one or more computing devices and may include multiple processors. The one or more computing devices in server device 24 may be server computing devices. Software executing on server device 24 may execute on a single device or may execute on multiple devices (e.g., as a distributed or parallel program). As shown in FIG. 1, server device 24 includes communication server 26 and video communication session 32. Each of computing devices 4 and server device 24 may be operatively coupled by communication channels 14-1 through 14-N (collectively referred to herein as “communication channels 14”). Communication channels 14 may be wired or wireless communication channels capable of sending and receiving communication data 40. Examples of communication channels 14 may include a 3G wireless network or a Transmission Control Protocol and/or Internet Protocol (TCP/IP) network connection over the Internet, a wide-area network such as the Internet, a local-area network (LAN), an enterprise network, a wireless network, a cellular network, a telephony network, a Metropolitan area network (e.g., Wi-Fi, WAN, or WiMAX), one or more other types of networks, or a combination of two or more different types of networks (e.g., a combination of a cellular network and the Internet).

Computing devices 4 connect to server device 24 through one or more network interfaces over communication channels 14. Computing devices 4-1 through 4-N may send data to or receive data from server device 24 via communication channels 14. Server 24 may be any of several different types of network devices and include one or more processors. For instance, server 24 may be a conventional web server, a specialized media server, a personal computer operating in a peer-to-peer fashion, or another type of network device. In other examples, server device 24 may provide conference calling capabilities in accordance with one aspect of this disclosure. For example, server device 24 may manage an N-way video conference between computing devices 4-1 through 4-N.

In one example, computing devices 4 exchange communication data 40, which may be streamed real-time. In some examples, communication data 40 may include visual data and audio data. Visual data may be any data that can be visually represented on a display device. Visual data may include one or more still images, a video, a document, a visual presentation, or the like. In one example, the visual data may be one or more real-time video feeds. As described herein, the visual data may comprise a plurality of visual data signals. In some examples, the visual data signals may be associated with a participant. In some examples, each computing device 4 provides a visual data signal as part of communication data 40.

In one example, communication data 40 may include audio feeds from the one or more participants. In some examples, at least part of communication data 40 may comprise speech of a participant (for example, a participant using computing device 4-2 may be speaking). As described herein, communication data 40 may comprise a plurality of audio data signals. In some examples, the audio data signals may be associated with a participant. In some examples, each computing device 4 provides an audio data signal as part of communication data 40.

In some examples, communication data 40 may be transferred between computing devices 4 over different channels 14. In one example, communication data 40 may be transferred using a Real-time Transport Protocol (“RTP”) standard developed by the Internet Engineering Task Force (“IETF”). In examples using RTP, visual data of communication data 40 may have a format such as H.263 or H.264. In other examples, other protocols or formats are used. In other examples, some or all of communication data 40 may be transferred encrypted, such as, for example, using Secure Real-time Transport Protocol (SRTP), or any other encrypted transfer protocol.

Computing devices 4 may connect to other computing devices 4, or to any other number of computing devices through server device 24. In other examples, computing devices 4 connect directly to each other. That is, computing devices 4 may be connected together in a peer-to-peer fashion, either directly or through a network. A peer-to-peer connection may be a network connection that partitions tasks or workloads between peers (e.g., a first computing device 4-1 and a second computing device 4-2) without centralized coordination by a server (e.g., server 24). Computing devices 4-1 and 4-2 may exchange communication data 40 via a peer-to-peer connection. In other examples, any combination of computing devices 4 may communicate in a peer-to-peer fashion.

As used herein, the letter N indicates a positive integer which may differ between examples. That is, in one example, N may be twenty for computing devices 4, twenty-two for users 2, and ten for communication channels 14.

Computing devices 4 are operatively coupled to a real-time video communication session 32 which enables communication between users 2 associated with computing devices 4. Although the systems and techniques described herein support conferencing capabilities, for illustrative purposes only, FIG. 1 will be described in terms of a real-time video communication between computing devices 4-1 through 4-N. However, it is to be understood that the techniques and examples described in accordance with this disclosure apply to communications having any number of two or more participants. Also, for illustrative purposes only, this disclosure refers to participants in the sense that there is a single participant user 2 (e.g., a person) for each computing device 4. However, it is to be understood that there may be more than one participant user 2 for each of computing devices 4. In other examples, any of computing devices 4 may be engaged in a video conference without a user 2.

This disclosure also describes, for illustrative purposes only, each of computing devices 4 as transmitting a single audio or video feed. However, it is to be understood that there may be more than one audio or video feed from each of computing devices 4. For example, more than one user 2 may be using a single computing device 4, such as, for example, computing device 4-3, to participate in a video conference. In such an example, computing device 4-3 may include more than one input devices 10-3 (e.g., two microphones and two cameras). In such an example, the techniques described in this disclosure may be applied to the additional audio or video feeds as if they were from separate computing devices 4.

In FIG. 1, computing devices 4 have established a real-time video communication, referred to herein as a video communication session 32. A user 2-1 operates first computing device 4-1 as a participant in the video communication session 32, and may be interchangeably referred to herein as a participant or as user 2-1. Similarly, as described herein for illustrative purposes only, three additional participants operate one of computing devices 4-2 through 4-N. As described above, in other examples, different numbers of participants and different numbers of computing devices 4 may be engaged in the real-time video communication session 32.

Computing devices 4 of FIG. 1 may include user clients 6. In some examples, user clients 6 may be mobile or desktop computer applications that provide functionality described herein. User clients 6 may include communication modules 8 as shown in FIG. 1. User clients 6 may exchange audio, video, text, or other information with other user clients and agent clients coupled to video communication session 32. Communication modules 8 may cause output devices of computing devices 4 to display graphical user interfaces. For instance, communication module 8-1 may cause output device 12-1 to display graphical user interface (GUI) 16.

Communication modules 8 may further include functionality that enables user clients 6 to couple to one or more video communication sessions (e.g., video communication session 32). Two or more computing devices (e.g., computing device 4-1 and computing device 4-3) may join the same video communication session 32 to enable communication between the computing devices.

As described throughout this disclosure a user or participant may “join” a video communication session when a user or agent client of a computing device associated with the user or participant couples, e.g., establishes a connection, to a communication server executing on a server device and/or other computing device. In some examples, a user client 6 executing on a computing device 4 joins a video communication session 32 by operatively coupling to a video communication session 32 managed by a communication server 26 executing on a server device 24 and/or other computing device 4.

In some aspects of the present disclosure, user clients 6 may enable users 2 to participate in a group-based multimedia support experience with multiple users. As further described herein, multiple user clients 6 may couple to video communication session 32 to discuss a same or a related topic.

Communication server 26 of server device 24 may comprise selection module 34. Selection module 34, in various instances, provides communication server 26 with capabilities to select which visual data from which computing devices 4 to provide for display. For example, output device 12 may display only a subset of the visual data received by server device 24. In other examples, communication server 26 contains further communication modules having additional capabilities.

Selection module 34 may select a subset of users 2 to be active participants. A participant in an active state may have visual data associated with that participant outputted by output devices 12 of computing devices 2. Those users 2 that are not selected to be active participants are passive participants. Visual data associated with passive participants will not be provided to computing devices 2 for display. Selection module 34 may select users to be active participants based on one or more participation properties.

In some examples, user client 6-1 causes output device 12-1 to display GUI 16. GUI 16 may include graphical elements such as text 18, video feeds 20-1 through 20-N (referred to collectively as “video feeds 20”), and visual data 22-1 through 22-N (referred to collectively as “visual data 22”). Graphical elements, more generally, may include any visually perceivable object displayable by output device 12-1 in GUI 16.

In the current example, input devices 10, generate visual data 22 while coupled to video communication session 32. Visual data 22 may be visual representations of users 2, such as a video of faces of users 2. In other examples, visual data 22 may be a still image or group of images (e.g., a video). User clients 6 may send the visual representations to communication server 26, which may determine that user clients 6 are coupled to video communication session 32. Consequently, communication server 26 may send visual data 22 only of users 2 that are determined to be active participants to user clients 6 as video feeds. User client 6, upon receiving the video feeds, may cause output device 12 to display the video feeds as video feeds 20. Video feeds 20 may include visual data 22 of active users 2. User client 6 may further cause input device 10 to generate visual data of selective active users 2. User clients 6 may further cause their respective output devices 12 to display visual data of selected active users 2 GUI 16. In this way, each user 2 may view a visual representation of one or more selected active users associated with a computing device 4 coupled to video communication session 32.

In addition to exchanging video information, the user clients 6 may exchange audio and other visual information via video communication session 32. For instance, microphones may capture sound at or near each of computing devices 4, such as voices of users 2. Audio data generated by user clients 6 from the sound may be exchanged between the user clients 6 coupled to video communication session 32. For instance, if user 2-2 speaks, input device 10-2 may receive the sound and convert it to audio data. User client 6-2 may then send the audio data to communication server 26.

Upon determining that user clients 6 are coupled to video communication session 32, communication server 26 may send the audio data to each of user clients 6. In some examples, only audio data from active participants are provided to computing devices 4 for output. Communication server 26 may determine that user client 6-2 is coupled to video communication session 32. Selection module 34 may determine whether user 2-2 is an active user. If user 2-2 is an active user, communication server 26 provides the audio data from user client 6-2 to the other user clients 6. After receiving the audio data, user clients 6 may cause output devices, for example, speakers of computing devices 4 to output sounds based at least in part on the audio data. In still other examples, text, such a real-time instant messages, or files may be exchanged between user clients using similar techniques. In other examples, a computing device 4 coupled to video communication session 32 generates a graphical representation of all or a portion of a graphical user interface generated by the computing device 4. The graphical user interface may then be shared with other computing devices 4 coupled to video communication session 32 thereby enabling other computing devices 4 to display the graphical representation of the graphical user interface.

Communication server 26, as shown in FIG. 1, may perform one or more operations that enable dynamic active participants in the video communication session 32. As shown in FIG. 1, server device 24 includes communication server 26. Examples of communication device 26 may include a personal computer, a laptop computer, a handheld computer, a workstation, a data storage system, a supercomputer, or a mainframe computer. Communication server 26 may generate, manage, and terminate video communication sessions such as video communication session 32. In some examples, communication server 26 may include one or more modules executing on one or more computing devices, such as server device 24, that performs operations described herein.

As shown in FIG. 1, communication server 26 includes components such as session module 30, video communication session 32, and selection module 34. Communication server 26 may also include components such as participant profile datastore 36 and participant status datastore 38. Components of communication server 26 may be physically, communicatively, and/or operatively coupled by communication channel 46. Examples of communication channel 46 may include a system bus, inter-process communication data structures, and/or a network connection.

In accordance with one or more techniques of the present disclosure, to select a set of users 2 to be active participants, selection module 34 may determine how many active participants video communication session 32 may support. That is, selection module 34 may determine a threshold number of active participants based at least partially on network and computing resources, such as bandwidth and processing power. As video signals consume more system resources, as opposed to audio, the constraints on at least one of network bandwidth and computing power limit the number of fully functioning participants in a video communication session. Instead of limiting the number of users 2 who may join video communication session 32, techniques of the present disclosure allow any number of users 2 to join video communication session 32. However, if the number of users 2 exceeds the threshold number of active participants, some of the users 2 may be passive participants.

A passive participant, for example, may listen in and watch the video communication session 32 without contributing visual data associated with the passive participants to the video communication session 32. In some examples, one or more audio feeds associated with a passive participant may be provided to computing devices 4 for output. However, in other examples, a passive participant may not be authorized to speak to other participants in video communication session 32. For example, it may not be desirable for every participant in a video communication session to be able to speak at any time. Such an example may include where the video communication session is used as a virtual classroom for distance learning, or mixed TV/online video hosting, or other at least partially interactive video conferencing environment.

The selection module 34 may initially set a subset of users 2 to be active participants. The initial subset may be, for example, equal to the threshold number of active participants (e.g., ten active users) of users who first joined video communication session 32. In other examples, selection module 34 determines the initial subset of users 2 to be active participants in other ways, for example, a queue.

In some examples, selection module 34 may receive information, such as an identifier of the computing devices 4 to join video communication session 32, an identifier of the users 2 associated with computing devices 4, and capabilities of computing devices 4 (e.g., video support, audio support, etc.). The capabilities of computing devices 4 may be used to determine the threshold number of active participants. In some examples, the threshold number of active participants is the same for each computing device 4. In other examples, the threshold number of active participants differs between computing devices 4 based on individual preferences or capabilities of computing devices 4.

Selection module 34 may dynamically update which users 2 are selected as active participants throughout video communication session 32. For example, selection module 34 determines whether a user is to be an active participant or not based on one or more participation factors. Selection module 34 may query participant profile datastore (PPD) 36 and participant status datastore (PSD) 38 to determine which users should be associated with active and passive states.

PPD 36 and PSD 38 may include any suitable data structure to store information such as a database, lookup table, array, linked list, etc. As shown in FIG. 1, PPD 36 may include information associated with each user 2. In one example, PPD 36 may include user identifiers that identify users 2 associated with computing devices 4 coupled to server device 24. PPD 36 may contain information related to a profile of a participant, including but not limited to, an identity of the participant, a designation of the participant for the video communication session 32 (e.g., teacher, student, moderator, host, presenter, etc.), a geographical location of the user, or the like. Additional information may be included in PPD 36 pertaining to statistics of a particular user 2, including, for example, how often user 2 is an active participant or a ratio of how many minutes user 2 speaks to a total number of minutes of previous communication sessions user 2 participated in.

PSD 38 may include information relating to a status of each user 2 during video communication session 32. Such information may include, for example, a status that each user 2 is currently associated with, i.e., passive or active. PSD 38 may also include information related to the current video communication session 32, such as, for example, a position in a queue of participants waiting to become associated with active status, whether an audio feed from a user contains speech, a duration since the user last spoke, or how long the user has been in the currently associated status. For instance, a status indicator associated with a user may indicate the user is passive or active. PSD 38 may also contain an indicator that a user wishes to become an active participant or a passive participant.

PPD 36 and/or PSD 38 may, in some examples, be included on one or more remote computing devices. PPD 36 and/or PSD 38 may be updated throughout video communication session 32. The one or more remote computing devices may execute a query on PPD 36 and/or PSD 38 and send the results to selection module 34.

Session module 30 may create, manage, and terminate video communication sessions, such as video communication session 32. For instance, when a video communication session is generated, session module 30 may maintain information that indicates the availability of video communication session 32. Session module 30 may generate video communication session 32 and send messages to user clients 6 that enable the respective clients to couple to video communication session 32. Once connected, users 2 may communicate about the requested topic. In some examples, multiple protocols may be used by selection module 34 to couple user clients and agent clients to video communication session 32. For instance, user clients and agent clients may couple to server device 24 using a first protocol while session module 30 and selection module 34 may communicate using a second protocol. Communication server 26 may apply protocol translation techniques to enable communication between different protocols.

A video communication session as used herein is a broad term encompassing as its plain and ordinary meaning, including but not limited to, one or more objects, which may be stored in and/or are executable by hardware, that may enable communication clients coupled to the one or more objects to exchange information. The one or more objects may include data and/or provide functionality of a video communication session as described herein. For instance, video communication session 32 may include data that, among other things, specifies user clients 6 coupled to video communication session 32. Video communication session 32 may further include session information such as a duration of video communication session 32, security settings of video communication session 32, and any other information that specifies a configuration of video communication session 32. Communication server 26 may send and receive information from user clients 6 coupled to video communication session 32 thereby enabling users participating in the video communication session to exchange information.

Techniques of the present disclosure may enable an unlimited number of participants in a video communication session, thereby potentially improving usability of the communication session over communication sessions with a limited number of participants. Techniques of the disclosure may also selectively determine an upper threshold number of active participants based on the network capabilities and computing resources for each computing device coupled to a video communication session, enabling users to utilize the resources of their particular computing device. This allows a participant using a first computing device with a higher processing power than a second computing device coupled to the video communication session to utilize the resources of the first computing device without taxing the second computing device. Alternatively, techniques of the disclosure may provide a uniform presentation of visual data to users in the video communication session.

Further, techniques of the disclosure may also automatically, dynamically update which users are active participants. In other examples, which users are active participants may be manually updated by another participant in the video communication session, such as a moderator. In still other examples, video communication sessions that provide multiple audio and video feeds may provide a media-rich environment that may improve collaboration and knowledge sharing. Techniques of the disclosure allow any value of participants (p), while still adhering to the maximum number of active participants (q) as imposed by available system resources. The techniques extend video conferencing from q-to-q way communication, to q-to-p way communication, where q is a dynamic subset of p.

Example Server Device

FIG. 2 is a block diagram illustrating further details of one example of computing device 4 shown in FIG. 1. FIG. 2 illustrates only one particular example of server device 24, and many other example embodiments of server device 24 may be used in other instances. Additionally, one or more computing devices 4 may be similar to server device 24 as shown in FIG. 2.

As shown in the specific example of FIG. 2, server device 24 includes one or more processors 60, memory 62, a network interface 64, one or more storage devices 66, input device 68, and output device 70. Server device 24 also includes an operating system 74 that is executable by server device 24. Server device 24, in one example, further includes communication server 26 that is also executable by server device 24. Each of components 60, 62, 64, 66, 68, 70, 74, 76, 26, 30, 32, 34, 36, 38, and 76 may be interconnected (physically, communicatively, and/or operatively) by communication channels 46, 72 for inter-component communications.

Processors 60, in one example, are configured to implement functionality and/or process instructions for execution within server device 24. For example, processors 60 may be capable of processing instructions stored in memory 62 or instructions stored on storage devices 66.

Memory 62, in one example, is configured to store information within server device 24 during operation. Memory 62, in some examples, is described as a computer-readable storage medium. In some examples, memory 62 is a temporary memory, meaning that a primary purpose of memory 62 is not long-term storage. Memory 62, in some examples, is described as a volatile memory, meaning that memory 62 does not maintain stored contents when the computer is turned off. Examples of volatile memories include random access memories (RAM), dynamic random access memories (DRAM), static random access memories (SRAM), and other forms of volatile memories known in the art. In some examples, memory 62 is used to store program instructions for execution by processors 60. Memory 62, in one example, is used by software or applications running on server device 24 (e.g., applications 76) to temporarily store information during program execution.

Storage devices 66, in some examples, also include one or more computer-readable storage media. Storage devices 66 may be configured to store larger amounts of information than memory 62. Storage devices 66 may further be configured for long-term storage of information. In some examples, storage devices 66 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Server device 24, in some examples, also includes a network interface 64. Server device 24, in one example, utilizes network interface 64 to communicate with external devices via one or more networks, such as one or more wireless networks. Network interface 64 may be a network interface card, such as an Ethernet card, an optical transceiver, a radio frequency transceiver, or any other type of device that can send and receive information. Other examples of such network interfaces may include Bluetooth®, 3G and WiFi® radios in mobile computing devices as well as USB. In some examples, server device 24 utilizes network interface 64 to wirelessly communicate with an external device such as computing devices 4 of FIG. 1.

Server device 24, in one example, also includes one or more input devices 68. Input device 68, in some examples, is configured to receive input from a user through tactile, audio, or video feedback. Examples of input device 68 include a presence-sensitive screen, a mouse, a keyboard, a voice responsive system, video camera, microphone or any other type of device for detecting a command from a user.

One or more output devices 70 may also be included in server device 24. Output device 70, in some examples, is configured to provide output to a user using tactile, audio, or video output. Output device 70, in one example, includes a presence-sensitive screen and may utilize a sound card, a video graphics adapter card, or any other type of device for converting a signal into an appropriate form understandable to humans or machines. Additional examples of output device 70 include a speaker, a cathode ray tube (CRT) monitor, a liquid crystal display (LCD), or any other type of device that can generate intelligible output to a user.

Server device 24 may include operating system 74. Operating system 74, in some examples, controls the operation of components of server device 24. For example, operating system 74, in one example, facilitates the interaction of one or more applications 76 (e.g., communication server 26) with processors 60, memory 62, network interface 64, storage device 66, input device 68, and output device 70. As shown in FIG. 2, communication server 26 may include routing module 28, session module 30, video communication session 32, and selection module 34, as described in FIG. 1. Applications 76, communication server 26, session module 30, video communication session 32, and selection module 34 may each include program instructions and/or data that are executable by server device 24. For example, session module 30 and selection module 34 may include instructions that cause communication server 26 executing on server device 24 to perform one or more of the operations and actions described in the present disclosure.

In accordance with aspects of the present disclosure, selection module 34 selects, from a plurality of participants in the communication session, one or more participates to be associated with an active state. The selection may be based on one or more participation properties.

Example Method

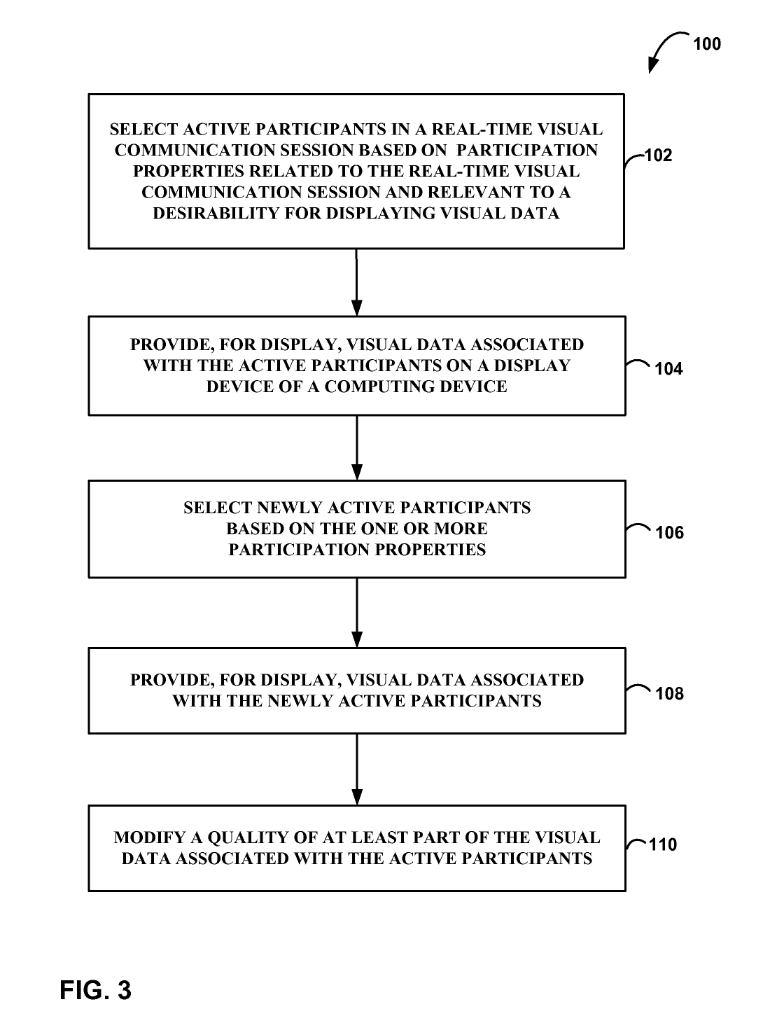

FIG. 3 is a flow chart illustrating an example method 100 that may be performed by a computing device to select active participants from a plurality of participants in a real-time visual communication session, in accordance with one or more aspects of the present disclosure. A real-time communication session may be a video conference or other visual communication session. Method 100 may further determine which visual data associated with two or more participants of a plurality of real-time communication session participants to provide for display on the computing device. For example, method 100 may be performed by computing devices 4 or server device 24 as shown in FIG. 1 or 2.

Method 100 may include selecting, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants, wherein one or more participants that were not selected comprise one or more passive participants each associated with a passive state (102). A desirability for displaying visual data associated with a participant may be associated with a level of participation of the participant, which may be determined by participation properties. A participation rating may be a rating, a score, or a ranking. In one example, method 100 determines a participation rating for each participant or computing device engaged in a real-time communication session. In another example, method 100 determines a participation rating for each separate visual data signal received by the computing device that is performing method 100 (e.g., computing device 2).

Participation properties may include factors relevant in determining a desirability level for displaying visual data associated with a participant during a video conference. Participation properties may further include qualities that can quantify participation of a participant in the video conference. Values may be assigned to some or all of the participation properties. In some examples, determining a participation rating may include totaling the values of the one or more participation properties. In another example, determining a participation rating may include averaging the values of the participation properties. Further, a participation rating may be a weighted average of participation properties. Selection module 34 may assign different, or approximately the same, weights to different participation properties.

In one example, a participation rating for a participant may be increased when one or more of the one or more participation properties indicate the participant is more actively participating than that participant previously was in the video conference. For example, active participation may include speaking or perform a function for the video conference (such as, for example, mediating or presenting). Likewise, the participation rating for the participant may be decreased when one or more of the one or more participation properties indicate the participant is less actively participating than the participant previously was in the video conference. For example, a less actively participating participant may be one who is listening or watching the video conference with minimal contribution. In one example, being an active participant may indicate that the participant is involved with the process of the video conference or otherwise contributing to it. In contrast, a non-active participant may be a passive listener or watcher of the video conference. As used herein, a “positive participation rating” refers to a rating which makes a participant more likely to be selected, and is not necessarily directed to any mathematical property of the rating.

One example conversation property may include whether a participant is currently speaking at a particular moment during the video conference. The speaking may be provided for output in the communication session or not. When a participant is speaking, selection module 34 may indicate the presence of this property, or assign a value (such as a positive value) to the property. In one example, any currently speaking participant may be given a highest rating or ranking of the plurality of participants. In another example, a weight may be assigned to the conversation property. In one example, a participation rating is increased when a participant begins speaking, and decreases when the participant ceases speaking. In some examples, a most recently used (MRU) algorithm may be used by selection module 34.

Another example conversation property may be a designation or determination that a participant has a particular designation in the video conference. For example, a participant may be an organizer, leader, or moderator of the video conference. In one example, a participant who called the meeting may be given a higher participation rating than that participant would otherwise receive. In another example, a moderator may be given a high participation rating in order that participants may be able to see the moderator at most or all times during the video conference. In another example, another type of designation may be used as a conversation property.

Further participation properties may include considerations of how often a participant has spoken. For example, a conversation property may include a duration a participant has spoken. In one example, the duration is a measure of how long a participant has been speaking since the participant began speaking. In another example, the duration a participant has spoken may be measured from the beginning of the conference call. A value assigned to the duration of speaking conversation property may increase with increasing amount of time the participant spoke. A positive correlation between the value of the conversation property and length of time speaking may be based on any mathematical relationship, including a linear or logarithmic relationship. Likewise, a value of any other conversation property may have a mathematical relationship to what the conversation property is measuring, if appropriate.

Similarly, another conversation property may include a duration since a participant has last spoken. In such an example, the participation rating for a participant who is no longer speaking may decrease correspondingly with the duration since the participant last spoke. In another example, a participation rating may decrease for a participant who was previously speaking only when the participant has not spoken for a threshold duration (for example, after a minute of not speaking).

Another conversation property may include a duration of how long a participant have been associated with a current status. For example, an active participant may have been active for a long time, and a moderator may wish to make that participant passive so another participant may have a chance at being an active participant. In some examples, a threshold time period is used to compare the status associated with a participant. When the participant has been associated with the status for the threshold time period, an action may be taken. The action may include the participant's participation rating going up, the status changed, or the participant moving up in a queue.

Another conversation property may include a determination of a ratio of the duration the participant has spoken to a total duration of the video conference. In one example, the more a participant speaks, the more likely other participants want visual data associated with that participant displayed on their computing devices. Thus, the participation rating of a participant may increase with increasing percentage of time that the participant has spoken during the video conference.

Yet another conversation property may include a relationship between a participant associated with one or more of the other participants. A relationship may be based on a social media status between the two or more participants. For example, if a first participant has a “friend” or “like” status with a second participant in a social media, both the first and second participants may have an increased participation rating for each other. In another example, only those participants who are a friend of the determining participant (that is, the user of the particular computing device that is making the determination) may be given a positive rating. Each participant's computing device 4 may display a different set of other participants based on their individual social graph or profile, that is, their individual set of friends.

In another example, a conversation property may include whether a participant has spoken the name of another participant. For example, computing device 4 may comprise speech recognition capabilities, which may be part of selection module 34. As communication data 40 may include speech, server device 24 may detect words spoken by a participant. In one example, server device 24 may detect when a participant is speaking directly to another participant. In such an example, if server device 24 detects a spoken name or other identifier associated with a participant, selection module 34 increases the participation rating of that participant. This increase may be removed or otherwise lessened with time. The identifier associated with a participant may be a name, a username, a login name, a role the participant is playing in the video conference (such as mediator or presenter, etc.), or the like. Potential identifiers may be stored in a database accessible by server device 24 (e.g., in PPD 36). These potential identifiers may be linked with one or more participants. Participants may be able to set security setting to indicate whether they want information related to them to be made available to server device 24 and stored in PPD 36 or PSD 38.

Quality of visual data from a computing device may also be a conversation property. In one example, a video quality conversation property is assigned a value based on a quality of the visual data associated with a participant. For example, a user may not wish to display visual data from a participant that is of poor quality. In one example, a participant may be entirely removed from consideration when a quality of the visual data associated with the participant is below a threshold quality level. In such an example, the computing device may still output audio data from a participant whose visual data is not displayed. Likewise, a relatively good video quality may be assigned a higher rating than a relatively poor video quality. In other examples, a relatively high video quality may be assigned a lower participation rating. For example, a computing device with limited processing power may not want to display relatively high resolution video data.

Another conversation property may be whether a participant is displaying or presenting a conference resource. Examples of conference resources may include using a whiteboard program, presenting a presentation, sharing documents, sharing a screen, or the like. In some examples, a conference resource may be displayed on a display device. In other examples, a conference resource may be displayed upon detection of an identifier of the conference resource (for example, a participant speaks a name of the conference resource).

Another conversation property may be based on email threads between a user and another participant. For example, if the user and a participant have recently emailed each other, the participation rating for the participant may increase. The video conference application may receive data from one or more email accounts associated with the video conference application. The data may include information related to whether the user has emailed any of the participants in the video conference. In addition, the video conference application may have access to the bodies of emails between participants in a video conference. A participation rating of a participant may be altered based on an email between the participant and the user. The participation rating may increase for a participant when an email is sent between the participant and the user during the video conference.

In another example, if a user has muted or otherwise blocked a participant, the participation rating for that participant may decrease with respect to the user. If the user un-mutes or no longer blocks the participant, the participation rating of the participant may increase.

In another example, a participation rating for a participant who speaks in relatively quick bursts may be lowered. This may be done in order to reduce a potential for rapid switching between participants based on which participant is currently speaking. Likewise, in some examples, a time delay may be passed before a newly selected participant may replace a previously selected participant. This delay period may be added in order to reduce a probability of rapid switching. For example, if a participation rating for newly selected participant decreases such that the newly selected participant would no longer be selected within the delay period, visual data associated with the newly selected participant may not be displayed. In other examples, other participation properties are used to reduce the occurrence of rapid switching.

Similarly, another conversation property may include a detection of a participant otherwise catching the attention of another participant, such as, by changing an image captured by a video camera. In another example, a conversation property may include detecting, via a camera, a movement by the participant. For example, a participant may perform a gesture, such as waving a hand, in order to get the attention of other participants in the video conference.

Yet another conversation property may include whether a participant has been selected by one or more other participants. For example, user 2 may select a participant in order to have visual data associated with the participant displayed on computing device 4. User 2 may select the participant from a list of the participants. In one example, user 2 touches a graphical representation of the visual data associated with the participant on GUI 16, wherein computing device 4 comprises a touch screen in order to select the participant.

Further participation properties may include a viewing mode each computing device is operating in (e.g., a full screen mode). Another conversation property may include whether a participant is presenting or sharing a screen, or attempting to present or share the screen. Also, if a first participant is a direct report for a second participant (for example, they have a supervising or employment relationship), the second participant may replace the first participant when the second participant speaks. Furthermore, information from other applications, such as a calendar application, may be used by selection module 34 to determine some of the participation properties.

Another conversation property may include which participants are viewing a shared resource. For example, the conference application may include the ability for users to optionally share a resource, such as watching a video together. Participants may be selected based on which participants are watching the video. A participant may receive a higher participation rating for a user who is watching a video if the participant has opted in to also watch the video. For example, not all participants of the conference may elect to watch the video, and only those participants watching the video may be displayed on the computing device associated with the user.

In some instances, some participants in a video conference may have additional communications between a subset of the participants in the video conference. For example, some participants in a video conference may also be engaging in a private or group text chat. Another conversation property may include whether a user is engaging in additional communications with another participant. If so, the participant may receive a higher participation rating for the user because of the additional communication. For example, a user is text chatting with a participant in the video conference, so the participant is displayed on the computing device used by the user. Further, the display of participants may be organized based on which participants the user may be chatting with. For example, in a video conference, participants who the user is chatting with may be displayed with a larger image than those participants the user is not chatting with.

Participation ratings may be determined individually for each participant. That is, for each user, the participation ratings for that participant and all other participants may be determined independently of other users' participation ratings. These separate determinations may be based on particular aspects of the relationship between the determining participant and the other participants in the video conference. Such relationships may include factors such as whether the determining participant is friends with the other participants, the presence of an employment or familial relationship, whether the determining participant has blocked a participant, etc. This enables different users of computing devices, such as computing devices 4, to see different sets of the plurality of participants as compared with other users or participants.

In another example, participation ratings for each participant may be the same among all users (e.g., among all the participants). In other examples, some determining participants may share, or have some of the same, participation ratings.

Participation ratings may be determined based on an algorithm. In some examples, the algorithm may be weighted such that some participation properties are weighted more than others. For example, a participation rating may be determined by adding together values assigned to participation properties. The values of the participation properties may be multiplied by coefficients.

For example, a participation rating for a participant may be based on whether the user is friends with the participant (e.g., like_factor), a ratio of how often the participant is speaking, and a ratio of how many times the participant has edited shared documents over the total number of edits to the shared documents. Such an equation to determine the participation rating may be shown in Equation 1:

$$Participation rating = A ( like\_factor ) + B ( \frac{number of minutes speaking}{total minutes of conference} ) + C ( \frac{number of edits}{total number of edits} ) \qquad ( 1 )$$

As shown in Equation 1, A, B, and C are coefficients used to weigh the different factors. The values of the coefficients may be different for different users and may be based on how important a particular conversation factor is to the user. Also, one user may have different coefficients for different participants. Equation 1 is an example equation showing three participation properties. However, participation ratings may also include additional factors based on other participation properties.

In some examples, a specific quality or presence of a particular conversation property for a participant may automatically result in selection of the visual data associated with that participant. For example, a participant who is currently speaking may always be selected for displaying the visual data associated with that participant. As another example, the presence of a conversation property, such as a designation, may be used to select a participant with that designation (e.g., meeting organizer, mediator, or presenter). In another example, only those participants who are friends with the determining participant are selected. In a further example, a participant may be selected as one of the two or more selected participants responsive to detecting an identifier associated with that participant.

If two or more participants have the same participation rating, and visual data associated with both participants cannot be active because the threshold number of active participants has already been reached, one participant may be selected based on another factor. In one example, a random participant among the tied participants may be chosen. In another example, the presence or absence of a selected conversation property may trump an otherwise tied participation rating. For example, a currently speaking participant may be selected over another participant with the same participation rating. In other examples, other methods of tie breaking are employed for selecting active participants.

As a video conference progresses, each participation rating for each of the plurality of participants may be updated throughout the video conference. In one example, the participation ratings are continuously updated. In other examples, the participation ratings are updated intermittently or at regular intervals. Likewise, the selection process may also be performed regularly, intermittently, or continuously throughout the video conference. In some examples, the selection process may be performed each time the participation ratings are updated.

Other selection options include a round-robin process. For example, a sliding window of q active participants circles around the p total participants at a constant or variable speed. Only those participants falling in the sliding window would be active participants.

Another option includes queuing. Participants register their intention to interact (e.g., by selecting an interact button), and are queued in a first-in-first-out manner. The top q participants in the queue become active participants. Previously active users may become idle through de-registering (toggling the interact button), on a time-share basis (e.g., a user exceeding a current share of usage is put at the back of the queue and waits for a next turn to be among the top q users), or by other means.

In other examples, a participation property may be a user vote. Those participants who are active may be selected by other participants through a voting process. If an inactive participant is highly requested or supported by other participants, that participant may become active by replacing the least popular or supported active participant. This may be desirable when the format of the communication session is a debate, for example.

In another alternative, a participant may designate whether they want to be considered to be an active participant when they join the communication session, or at any other time during the communication session. For example, a participant may wish to only listen, and thus selects an option to not be considered for active participation.

Method 100 may further include selecting, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants, wherein one or more participants that were not selected comprise one or more passive participants each associated with a passive state (104).

Method 100 may further include providing, for display, a first set of visual data associated with the one or more active participants on a display device of a computing device (106). Method 100 may further include selecting one or more newly active participants from the passive participants based at least in part on the one or more participation properties related to the real-time visual communication session, wherein the one or more newly active participants become associated with the active state, and wherein a total number of participants associated with the active state does not exceed a threshold number of active participants (108).

Method 100 may further include providing, for display, a second set of visual data associated with the one or more newly active participants on the display device of the computing device (110). Method 100 may also include, responsive to providing the second set of visual data for display, modifying a quality of at least part of the displayed first set of visual data (112).

In other examples, how the visual data associated with the participants will be displayed may be based on the one or more participation properties or an order of selection. For example, newer active participants may be selected to be displayed having a larger displayed image than older active participants. In one example, all the participants may be displayed on the computing device at least as thumbnail images, while some active participants are displayed with larger images. In other examples, active participants may be selected in order to display visual data associated with the selected active participants in a certain position or orientation. In further examples, visual data associated more newly active participants may have brightness different from visual data associated older active participants. In other examples, the display of visual data associated selected participants may differ from the display of visual data associated older active participants in other ways, including color, quality, compression rate, duration of display, or the like.

When a previously active participant becomes a passive participant, visual data associated with the previously active participant may be replaced with visual data of the next oldest active participant, or the participant with the next lowest participation rating.

A participant may be notified if visual data associated with him or her is selected for one or more other participants. In another example, an indication is provided to each participant of what their participation rating is, which may be an average of participation ratings for that participant among all the users.

In some examples, a particular participant acts as a moderator for the communication session (e.g., the initiator of the communication session, the teacher of a classroom, the host in an online radio talk program). The moderator may control and select which participants are active and can fully interact at any moment throughout the communication session. The active participants will have their video and audio input transferred in real-time to all participants. That is, the active participants may be displayed on the screen of all participants (both active and inactive), with their videos updated in real-time. In one example, the moderator has a scaled-down view of all the participants regardless of their status, as well as an indication of their status (active or passive), displayed on a display device. Examples of the scaled-down view include a compressed or coarse video of the participants, a fixed picture, or other identifier (e.g., an email address) with their online status indicated.

For example, a moderator's display device may include currently active participants shown in a larger or finer granular view on one side of a screen (e.g., a top side), while inactive users are shown in smaller/coarser views on an opposite side of the screen (e.g., a bottom side). By using scaled-down views on inactive users, network bandwidth can be saved dramatically, while user interactions can still remain intensely engaging. Buttons, such as virtual touch-targets, may be provided to the moderator to toggle participants between active and passive status. Display devices of other participants may show both active and passive participants with the same user interface as the moderator, but without any control buttons to modify the status of the participants. Alternatively, the screens of the non-moderator participants may be displayed with only active participants.

In other examples, each participant may be able to communication with other participants via private or group text chat through the communication session. Furthermore, each participant may have one or more interact buttons provided on the GUI that enables the participant to indicate whether she or he wants her or his status to be changed. Toggling the button may place the participant in a queue to become an active participant. In examples with a moderator, an indication of the participant's wishes may be provided to the moderator. The indication may comprise a flashing light or change of color on the moderator's scaled-down view. Additionally, the participant's intent may be broadcast to all participants in the communication session.

A participant's active/passive state can be kept on the central server, such as server 24, that provides the video communication session. Alternatively, participants' statuses may be kept on the moderator's browser.

A participant's status may be indicated to the participant, such that the participant knows whether the participant is among the active participant displayed to other participants.

An example functioning of one or more techniques of the disclosure is provided here. A list of current active participants at any moment during the communication session is limited and smaller than the total number of participants (for example, 10 active participants). In one example, visual data associated with the active participants may be displayed at a larger/higher granularity than the rest of the passive participants. Alternatively, a current speaking active participant is displayed with the largest size (for example, a display size of 30% of the screen designated for active participant visual data). The immediately previous speaker is displayed with a smaller size that then current speaker (for example, a display size of 25% of the screen space). This size may be one size level lower than the largest size. When another active participant speaks, that participant becomes the current speaker and is displayed with the largest size (e.g., 30%). The size of all the previous speakers are reduced by one level in the display. This resembles a least-recently-used (LRU) cache replacement algorithm: the most recent speaker is displayed the “largest,” while the most ancient (least recent) speaker is displayed the “smallest.” Hence, in this example the display layout change whenever another person (someone other than the current speaker) speaks.

In one example, instead of instantaneous change in picture size when another person speaks, the displayed images all change gradually and smoothly.

Example GUI

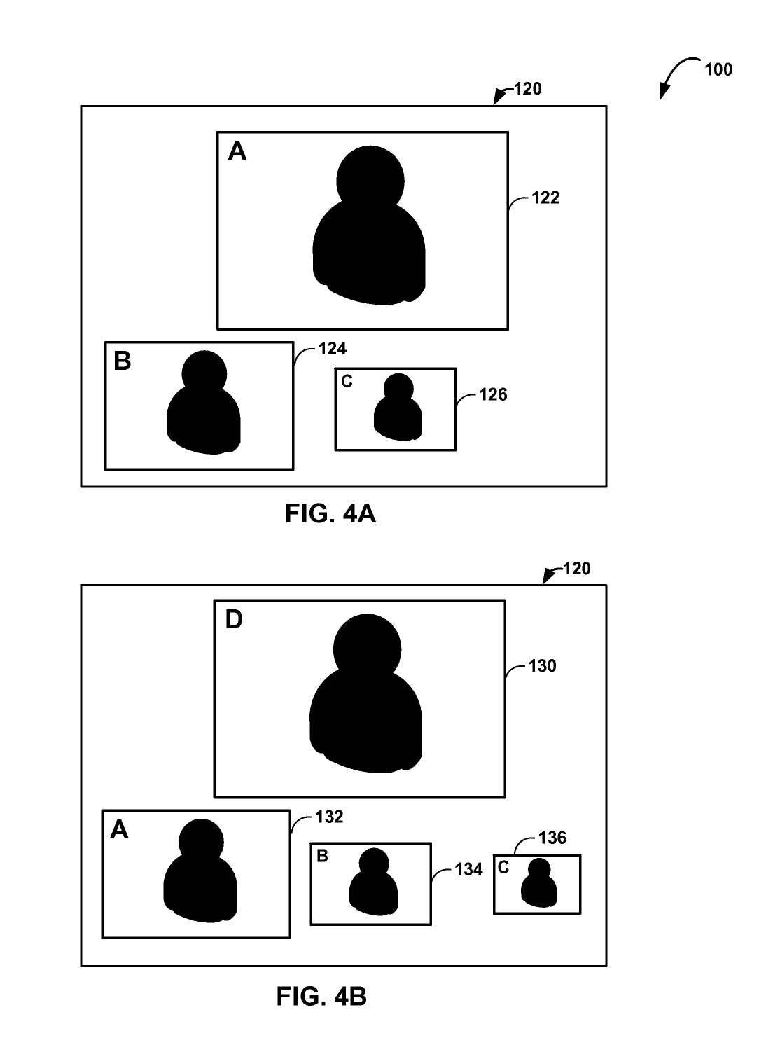

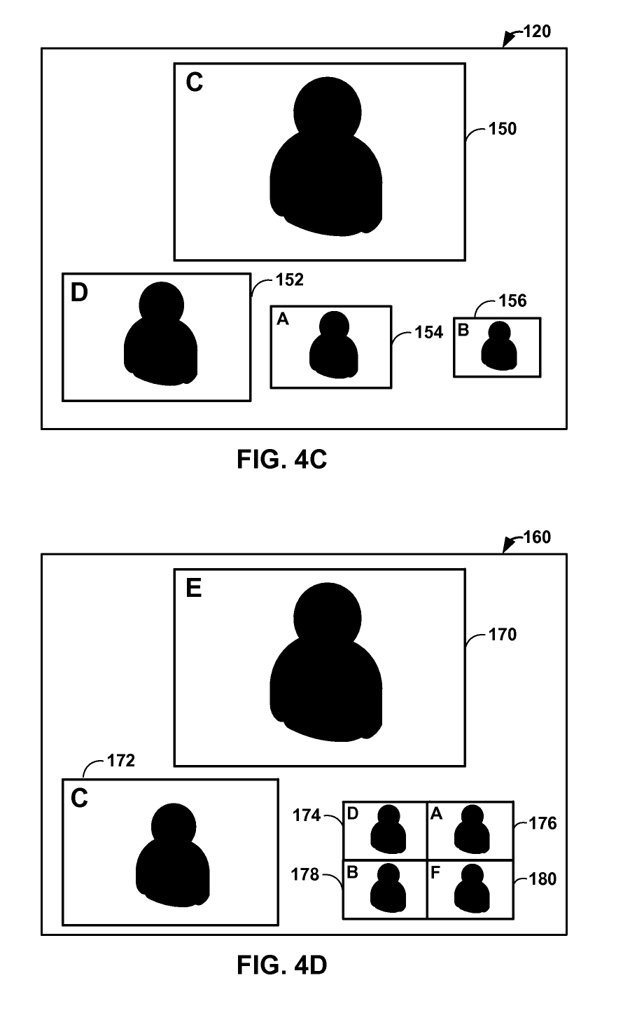

FIGS. 4A-4D are a block diagrams illustrating an example graphical user interface (GUI) that may be provided by a computing device to display visual data of active participants in a real-time visual communication session, in accordance with one or more aspects of the present disclosure. For illustrative purposes, FIGS. 4A-4D are discussed in terms of a communication session between ten different participants. The predefined threshold number of active participants is four.

FIG. 4A shows a GUI 120 of a user computing device, such as computing device 4-1 of FIG. 1, at a first time, Time 1. There are three active participants in the communication session at Time 1, namely, A, B, and C. Up until this time, only three participants have been selected to be active, even though the predefined threshold number of active participants is four. At time 1, A is currently speaking Visual data associated with A 122 is displayed because A is an active participant. Visual data 122 is displayed at size 5. Similarly, visual data associated with B 124 and visual data associated with C 126 are displayed. Visual data 124 is displayed at size 4 and Visual data 126 is displayed at size 3. The sizes may correspond to ratios of display size, levels of selected sizes, or other characteristic. In other examples, at least one of the visual quality or size may be modified based on participation properties.

FIG. 4B shows a GUI 120 of the user computing device at a second time during the visual communication session later than the first time, Time 2. At time 2, D (a newly active participant) is speaking. In some examples, D may have been selected to be an active participant because D began speaking Visual data associated with D 130 is displayed because D is an active participant. Visual data 130 is displayed at size 5. Similarly, visual data associated with A 132, visual data associated with B 134, and visual data associated with C 136 are displayed. At time 2, the sizes of the displayed images are as follows: A(4), B(3), C(2), D(5).

FIG. 4C shows a GUI 120 of the user computing device at a third time during the visual communication session later than the second time, Time 3. At time 3, C begins speaking. Visual data associated with C 150 is displayed at size 5. Similarly, visual data associated with D 152, visual data associated with A 154, and visual data associated with B 156 are also displayed. The displayed images are as follows at Time 3: A(3), B(2), C(5), D(4).

FIG. 4D shows a GUI 160 of the user computing device at a fourth time during the visual communication session later than the third time, Time 4. Additionally, FIG. 4D shows GUI 160 having a different layout than GUI 120, for illustrative purposes. In some examples, GUI 160 is not at Time 4, but is an example independent of example of GUI 120. In the example of GUI 170 shown in FIG. 4D, six participants have been selected for display. Four sets of video data are displayed in a 2 by 2 matrix.

At time 4, a newly active participant, E, has been selected and is speaking. Because the predefined threshold number of active participants is defined at 4, one of the previously active participants is dropped. Visual data associated with E 170 is displayed at size 5. Similarly, visual data associated with C 172, visual data associated with D 174, visual data associated with A 176, visual data associated with B 178, and visual data associated with F 180 are also displayed. Visual data associated with F 180 has been introduced in this example because there are more active participants displayed in GUI 160. In this example, because B was the least active participant and had the smallest display size, B has been changed to a smaller size. The displayed images are as follows at Time 4: A(2), B(2), C(4), D(2), E(5), F(2). This “fading” scheme would produces a smooth impression, and illustrate a clear timeline on who spoke recently.

Regarding a physical layout of the display, many options can be used. For example, the active participants may be listed from left to right, sorted by their most recent communication, so the displays are from large to small (left to right). In another example, the active participants are fixed in their order from left to right, but their display sizes are based on their time of most recent communication. The size of “active speakers” can be controlled by setting a hard number (e.g., 10 or 5) or setting a time window (e.g., who has spoken in the last 5 minutes), for example.

Techniques of the present disclosure may provide an improved user experience during video conferences. A set of participants may be displayed in a size appropriate for the user to see the relevant information. The techniques allow a user to see those people who are part of a conversation in the video conference. Participants who are relevant to the conversation at any particular time are brought up to be displayed, while participants who become less relevant to the conversation are dropped off. In this way, techniques of the disclosure dynamically create a group of panelists, which may be the same or different for each user.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, computer-readable storage media may comprise a tangible or non-transitory media. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. Aspects or features of examples described herein may be combined with any other aspect or feature described in another example. These and other embodiments are within the scope of the following examples.

1. A method, comprising:
selecting, using one or more computing devices, from a plurality of participants in a real-time visual communication session, at least a first, second, and third active participant to each be associated with an active state based at least in part on one or more participation properties related to the real-time visual communication session and relevant to a desirability for displaying visual data associated with a participant for each of the plurality of participants;
providing, for display on a display device of a user computing device, using the one or more computing devices, first visual data associated with the first active participant, second visual data associated with the second active participant, and third visual data associated with the third active participant;
selecting, using the one or more computing devices, one or more newly active participants from one or more participants that were not selected as active participants based at least in part on the one or more participation properties related to the real-time visual communication session, wherein the one or more newly active participants become associated with the active state;
providing, for display, using the one or more computing devices, fourth visual data associated with the one or more newly active participants on the display device of the computing device; and
responsive to providing the fourth visual data for display, modifying a quality of the displayed first, second, and third visual data.

2. The method of claim 1, further comprising:
designating a first participant of the plurality of participants as a moderator, wherein the moderator is authorized to change the status of other participants of the plurality of participants, and wherein visual data associated with the moderator is always provided for display on the display device of the computing device during the real-time visual communication session.

3. The method of claim 1, further comprising:
comparing a number of participants associated with the active state to the threshold number of active participants; and
responsive to the comparison, selecting the one or more newly active participants when the number of participants associated with the active state is less than the predefined threshold number of active participants.

4. The method of claim 1, further comprising:
comparing a number of participants associated with the active state to the predefined threshold number of active participants; and
responsive to the comparison, selecting one or more participants associated with the active state to be associated with a passive state based at least partially on the one or more participation properties when the number of participants associated with the active state exceeds the threshold number of active participants.

5. The method of claim 1, further comprising:
determining that a first participant associated with the active state should no longer be an active participant at least partially based on one of the participation properties;
changing the state associated with the first active participant from the active state to a passive state; and
selecting a second participant from the one or more participants that were not selected as active participants based at least partially on one of the participation properties, wherein a state of the second participant is changed from the passive state to the active state.

6. The method of claim 1, wherein the one or more participation properties related to the real-time visual communication session comprises, for at least one participant of the plurality of participants, at least one of a position in a queue, a duration in the active state, a duration in a passive state, a designation, an identity, content of an audio output, a status of a user-selectable option, a round-robin process, participant voting results, a ratio of a duration the participant has spoken and a total duration of the real-time visual communication session, a duration since the participant last spoke, a geographical location of the participant, the presence of a conference resource associated with the participant, properties of a computing device associated with the participant, and any combination thereof.

7. The method of claim 1, further comprising:
receiving one or more signals indicating that a first participant of the plurality of participants is a listener; and
responsive to receiving the one or more signals, setting a state associated with the first participant to passive for a duration of the real-time visual communication session.

8. The method of claim 1, wherein one or more participants that were not selected as active participants comprise one or more passive participants each associated with a passive state;

9. The method of claim 8, wherein selecting one or more newly active participants from the passive participants based at least in part on the one or more participation properties related to the real-time visual communication session further comprises:
determining a participation rating for each of a plurality of participants, wherein the participation rating is based at least in part on the one or more participation properties;
increasing the participation rating for a participant when one of the one or more participation properties for the participant indicates the participant is more actively participating in the real-time visual communication session than the participant was previously participating;
decreasing the participation rating for the participant when one of the one or more participation properties for the participant indicates the participant is less actively participating in the real-time visual communication session than the participant was previously participating; and
selecting the one or more participants to be active based on the participation rating of each of the plurality of participants.

10. The method of claim 8, wherein the one or more newly active participants are selected from the passive participants.

11. The method of claim 1, wherein modifying the quality of at least part of the displayed first set of visual data comprises reducing at least one of an visual quality or an output size of the visual data related to at least one of the active participants.

12. The method of claim 1, wherein modifying the quality of at least part of the displayed first set of visual data further comprises iteratively reducing the quality of visual data associated with at least one active participant for each selected newly active participant.

13. The method of claim 12, further comprising:
iteratively reducing the quality of at least part of the displayed second set of visual data once for each participant changed from a passive state to the active state; and
changing the status of a participant from the active state to a passive state once the quality of the displayed visual data associated with the participant reaches a quality threshold level.

14. The method of claim 1, wherein visual data associated with a participant is only provided for display on the display device of the computing device when the status of the participant is active.

15. The method of claim 1, further comprising:
providing, for output by the computing device, audio data associated with each participant only while the participant is associated with the active state.

16. The method of claim 1, further comprising:
providing, for output by the computing device, audio data associated with each participant of the plurality of participants.

17. The method of claim 1, further comprising:
determining the threshold number of active participants based at least partially on network resources associated with the real-time visual communication session and computer resources of the computing device.

18. A computer-readable storage medium comprising instructions for causing a programmable processor to perform operations comprising:
selecting, using one or more computing devices, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants;
providing, for display, using the one or more computing devices, a first set of visual data associated with the one or more active participants on a display device of a user computing device;
selecting, using the one or more computing devices, one or more newly active participants from one or more participants that were not selected as active participants based at least in part on the one or more participation properties related to the real-time visual communication session, wherein the one or more newly active participants become associated with the active state, and wherein a total number of participants associated with the active state does not exceed a predefined threshold number of active participants;
providing, for display, using the one or more computing devices, a second set of visual data associated with the one or more newly active participants on the display device of the computing device; and
responsive to providing the second set of visual data for display, modifying a quality of at least part of the displayed first set of visual data.

19. The computer-readable storage medium of claim 18, the operations further comprising:
determining that a first participant associated with the active state should no longer be an active participant at least partially based on one of the participation properties;
changing the state of the first active participant to be associated with a passive state; and
selecting a second participant to replace the first participant at least partially based on one of the participation properties, wherein a state of the second participant is changed from a passive state to an active state, such that a number of participants who are in an active state equals the threshold number of active participants.

20. The computer-readable storage medium of claim 18, wherein modifying a quality of at least part of the displayed first set of visual data further comprises:
iteratively reducing the quality of an visual data associated with at least one active participant for each newly active participant selected and changed from a passive state to the active state; and
changing the status of a participant from the active state to the passive state once the quality of the displayed visual data associated with the participant reaches a quality threshold level.

21. A server comprising one or more processors, the one or more processors being configured to perform a method of:
selecting, using one or more computing devices, from a plurality of participants in a real-time visual communication session, one or more active participants to each be associated with an active state based at least in part on one or more participation properties related to the real-time visual communication session and relevant to a desirability for displaying visual data associated with a participant for each of the plurality of participants;
providing, for display, using the one or more computing devices, a first set of visual data associated with the one or more active participants on a display device of a user computing device;
selecting, using the one or more computing devices, one or more newly active participants from one or more participants that were not selected as active participants based at least in part on the one or more participation properties related to the real-time visual communication session, wherein the one or more newly active participants become associated with the active state, and wherein a total number of participants associated with the active state does not exceed a predefined threshold number of active participants;
providing, for display, using the one or more computing devices, a second set of visual data associated with the one or more newly active participants on the display device of the computing device; and
responsive to providing the second set of visual data for display, modifying a quality of at least part of the displayed first set of visual data.

22. The server of claim 21, wherein modifying the quality of at least part of the displayed first set of visual data further comprises
iteratively reducing the quality of an visual data associated with at least one active participant for each newly active participant selected and changed from a passive state to the active state; and
changing the status of a participant from the active state to the passive state once the quality of the displayed visual data associated with the participant reaches a quality threshold level.
